(19) United States
(12) Patent Application Publication
(10) Pub. No.: US 2014/0144734 A1
(43) Pub. Date: May 29, 2014

(54) Auto Brake Set - Air Brake Application

(71) Applicant: Michael Edward Sherrer, Camano Island, WA (US)

(72) Inventor: Michael Edward Sherrer, Camano Island, WA (US)

(21) Appl. No.: 13/966,838

(22) Filed: Aug. 14, 2013

Related U.S. Application Data
(60) Provisional application No. 61/683,660, filed on Aug. 15, 2012.

(51) Int. Cl. B60T 13/38

(52) U.S. Cl. CPC B60T 13/385
USPC 188/170

(57) ABSTRACT

An apparatus and method for improving the application of air brakes in the event a driver fails to apply the brakes upon exiting the driver area. The vehicles brakes will be applied automatically in the event the driver forgets. This will be done by blocking the air flow and exhausting the air that is present in the lines. The air will not be restored to said vehicle until the driver is back in control of this vehicle and manually resets the brake valve.

This invention claims priority via a provisional application No. 61/683,660 dated Aug. 15, 2012.

This invention is a method to cease the air flow and evacuate the air used to release the air brakes on any vehicle that used air as a means to hold back the springs thus allowing the vehicle to move. upon activation of the sensing switch the brakes will then be set automatically by a series of relays and solenoid valves.

It helps to eliminate the error of a driver failing to manually engage the air valve that is supplied with all vehicles that require air as a means to engage or disengage the brakes. The Invention will activate a series of relays and valves anytime a driver vacates the cab area and is no longer in a controlled area of said vehicle.

The results of this action will stop the air flow and take away the air pressure present in air supply lines thus allowing the springs to take over and push the brake pads or shoes out against drums to keep vehicle from moving. The supply air back to the air lines it will require the driver to be back in control and manually re-set the manual valve.

### BACKGROUND OF INVENTION

On all vehicles that require pressure as the source to either release or apply the brakes there has always been a problem with driver error.

The driver has to activate a manual valve to either move said vehicles or apply the brakes to keep said vehicle from moving.

Drivers failing to do so have resulted in numerous deaths and property damage, as well as environmental hazards. Such as jet fuel spills and other refined fuels.

This invention will reduct the driver error and help eliminate Deaths, Property damage and Environmental damage.

This idea and subsequent invention came about as the result of discussions with Labor and Industries after a death due to driver error by not manually applying brakes to the vehicle. As well as a discussion with the Department of Defense on the property damage on jet fighters.

### SUMMARY OF THIS INVENTION

This invention is needed to eliminate the possibility of driver error to manually disengage a valve to apply brakes upon leaving the controlled area of aforementioned vehicles. A sensing switch will be used to show that the driver is no longer in control of the vehicle and engage a series of relays and contacts which will supply power to solenoid valves blocking the air pressure and at the same time the air present in lines will be evacuated from said system allowing the brakes to be applied. In order for the vehicle to move, the driver will be required to be back in control of vehicle and manually activates the valve to once again supply air to the system which will result in normal operation of vehicle.

### BRIEF DESCRIPTION OF DRAWINGS

FIG. 1 Electrical

FIG. 3 is the power source that is used to supply power to this system

FIG. 4 is the wiring necessary to conduct the electrical supply to activate the system

FIG. 5 is a sensing switch that is biased normally closed.

FIG. 6 is a relay coil

FIG. 7 is a set of normally open contacts contained within the relay.

FIG. 8 is a solenoid coil that operates the normally open valve body.

FIG. 9 is a set of normally open contacts contained within the relay.

FIG. 10 is a solenoid coil that operates the normally closed exhaust valve body

FIG. 2 Pneumatic

FIG. 12 is an air pressure tank.

FIG. 13 is a drain valve.

FIG. 14 is a supply line.

FIG. 15 is a solenoid valve normally open.

FIG. 16 is an air line four position tee.

FIG. 17 is a solenoid valve body normally closed

FIG. 18 is the exhaust line for FIG. 15

FIG. 19 is a solenoid valve body normally closed.

FIG. 20 is the exhaust line for FIG. 17.

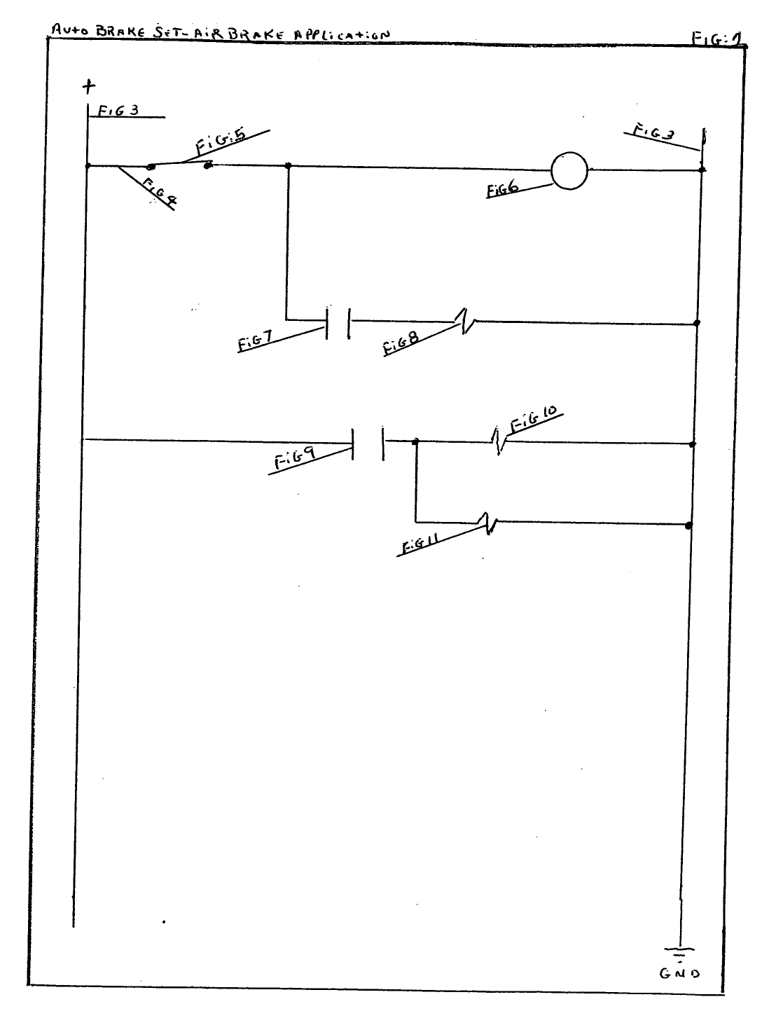

FIG. 21 is a manual air valve on FIGS. 1 and 2 for illustration purposes only and is supplied by the O.E.M. and is common on all vehicles using air as the means to either apply brakes or release brakes.

### DETAILED DESCRIPTION OF DRAWINGS

FIG. 1: Electrical schematic

FIG. 3 is a power source that has a positive and a negative position. This source can be derived from many different means and will be used to supply enough voltage to correctly operate the coils that are used to either open or close contacts in the relays or to open and close the solenoid valves to adequately cease the air flow and open the solenoid valves to exhaust the air present in said air lines supplying pressure to manual tractor valves.

FIG. 4 is the electrical wiring that is sized to adequately carry the necessary power to the electrical relays and solenoid valves without creating any overheating problems that could be a result of under sizing.

FIG. 5 is a sensing switch that is used to determine whether or not a driver is in control of vehicle. This switch is biased normally closed by a spring and by the absence of pressure upon this switch, resulting in the contacts being closed. Pressure applied to switch will result in the switch becoming open.

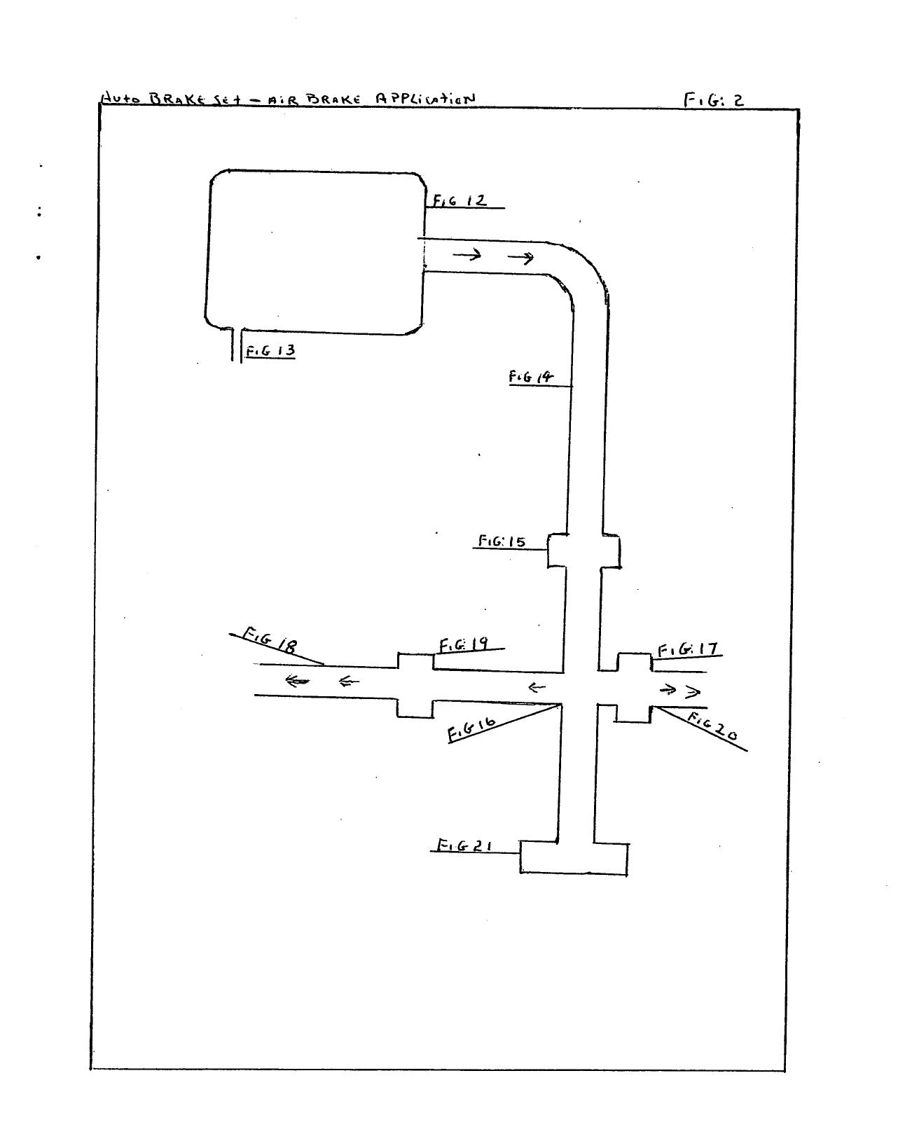

FIG. 6 is a relay coil that is used to open or close a set of contacts contained within the relay its self. The voltage will be supplied by FIG. 3 power source and FIG. 4 wiring. The coil in its normal state is what determines the contacts within as to the position of normally closed or normally open status. This relay coil is sized according to the necessary draw on the system to adequately perform the function of changing the status of said contacts contained within.

FIG. 7 is the first set of contacts referred to in FIG. 6 depending on whether or not there is power supplied to the coil will determine the state of this set of contacts. This set of contacts is normally open and will change to closed upon activation.

FIG. 8 is a solenoid coil and will be of sufficient size due to the valve body requirements and the air pressure present in FIG. 14 to include the magnification required to adequately close the air valve in FIG. 15, thereby ceasing the air flow that is present in FIG. 13.

FIG. 9 is the second set of normally open contacts depicted in FIG. 6 and when activated by FIG. 5 and supplied by FIG. 3 and FIG. 4 the contacts will close and supply the necessary voltage to FIG. 10.

FIG. 10 is a solenoid coil and will be of sufficient size due to the requirements to overcome the air pressure present in FIG. 14. The valve body and its requirements are sufficient to operate the magnification and adequately close the air valve in FIG. 15, thereby closing the valve body and ceasing the flow of air pressure.

FIG. 11 is a solenoid coil and will be sufficient size due to the requirements to overcome the air pressure present in FIG. 15. The valve body and its requirements are sufficient to operate the magnification and adequately open the air valve in FIG. 17, thereby opening the valve body and exhausting the flow of air pressure that is present via FIG. 18.

FIG. 2: Pneumatic

FIG. 12 is an air reservoir tank. This tank is the source of the needed air supply and pressure that is required to operate brake system on any vehicle that uses air as it source to engage or disengage brakes.

FIG. 13 is a drain valve for the tank in FIG. 12 to drain off any condensation accumulation to prevent moisture from getting into the air lines in FIG. 14.

FIG. 14 is a supply air line of sufficient size to adequately supply enough volume and pressure to valve bodies for the operation of brake application.

FIG. 15 is a solenoid valve that is plumbed normally open. This valve body is directly activated by FIG. 8. Upon activation the valve body will change from the normally open to closed position, thus stopping the air flow to the rest of the system.

FIG. 16 is an air line four position tee. This allows air flow to the incoming air supply to be directed in three different directions. Two of which are the exhaust valves and one to the tractor valve. With FIG. 15 having been actuated at this point, the air flow to the tractor will be eliminated and will only be restored when driver resets manual valve.

FIG. 17 is a solenoid valve body that is plumbed normally closed and will be opened by the activation of FIG. 11 and the resulting actuation of FIG. 15, which will result in the evacuation of air present in the line FIG. 14.

FIG. 18 is the air line that provides the path for air pressure at the point shown in FIG. 16 to be exhausted into the atmosphere.

FIG. 19 shows the second solenoid that will aid the rapid evacuation of the air pressure that is present at this point upon activation of FIGS. 6 and 17.

FIG. 20 is the air line that provides the path for air pressure at the point shown in FIG. 19 to be exhausted into the atmosphere. This results in the air line to be virtually free of air pressure and requiring the operator to manually reset the air to the entire system before vehicle will mode.

FIG. 21 is the O.E.M. valve that is common on all vehicles that use air to apply or release the brakes. This valve is biased normally closed and is opened manually to supply the needed air to release the brakes that are being held against the rotor or disc by springs. When air pressure drops below a preset point the spring inside the valve will take over and exhaust the air thus allowing.

The invention claimed is:

1. An electrically controlled and pneumatic system to stop the air flow to the brakes and at the same time evacuate the air present in said lines to allow the springs inside the tractor valve to take over and keep the vehicle from moving. This will be done whenever the driver activates a sensing switch by leaving the control position inside the vehicle and will need to be present to manually reset brakes before vehicle will move.
The electrical part of claim 1 is the power source that will supply the needed power to start activation.
The electrical part of claim 1 will be supplied to the system by means of an electrical conductor.
The electrical conductor in claim 1 will supply electricity to the sensing switch.
The sensing switch in claim 1 when activated will supply power to the relay coil.
The relay coil in claim 1 will activate and close or open a set of contacts contained within.
The relay coil in claim 1 will close a set of normally open contacts.
The contacts in claim 1 will supply power to a pneumatic solenoid coil.
The pneumatic solenoid coil in claim 1 will activate a valve body.
The relay coil in claim 1 will close a second set of contacts supplying power to a pneumatic coil.

2. The air reservoir tank in FIG. 2 Pneumatic Auto Brake Set-Air Brake series is comprised of air lines and tees needed to supply the air to the brakes or take the air present and evacuate it into the atmosphere.
Upon activation by the claim 1, these valves will shift to be in their normal state and will shift back to the opposite position upon de-activation of claim 1. Thus allowing normal operation of the brakes but requiring the driver to be present in the control position of said vehicles.
The air line is the delivery system that connects the air tank in claim to the rest of the system.
The solenoid valve body upon activation will close not allowing any more air to proceed past that point.
The airline four position tee in claim 2 is used to connect to more than one pneumatic solenoid valve.
There are two separate solenoid valves used to exhaust and evacuate the air pressure present at that point.
Is the atmosphere release of the air present in both solenoids in claim 2.
This is a tractor valve that is common in all air operated equipment and is in drawing for illustration purposes only. This valve is supplied by the O.E.M.
